(19) United States
(12) Patent Application Publication
(10) Pub. No.: US 2016/0200965 A1
(43) Pub. Date: Jul. 14, 2016

(54) SPRAY SET-UP FOR ON-THE-FLY TREATMENT OF PROPPANTS

(71) Applicant: TRICAN WELL SERVICE LTD., Calgary (CA)

(72) Inventors: Grant Farion, Okotoks (CA); Kewei Zhang, Calgary (CA); Mike Burvill, Jarvis Bay (CA)

(21) Appl. No.: 14/993,030

(22) Filed: Jan. 11, 2016

(30) Foreign Application Priority Data
Jan. 9, 2015 (CA) 2877025

(51) Int. Cl. C09K 8/68; C09K 8/80; B05B 1/04; E21B 41/00; B05B 1/20

(52) U.S. Cl. CPC C09K 8/68; E21B 41/00; B05B 1/20; B05B 1/04; C09K 8/80

(57) ABSTRACT

A proppant slurry is formed by lifting dry proppant using one or more augers and distributing an additive to modify the dry proppant as it falls from the top of the augers into a blender tub. Water is added to the blender tub and the modified proppant for forming the proppant slurry. The additive hydrophobically modifies surfaces of the proppant, typically sand, to produce stable proppant/bubble aggregations for forming proppant packs when introduced into formation fractures. The additive is distributed using main spray nozzles directed downwardly onto the falling proppant in a direction of fall of the proppant. Auxiliary spray nozzles protrude upwards into the proppant and distribute additive within and beneath the falling proppant and in a direction of travel thereat. Spray orifices further distribute additive to the falling proppant.

### CROSS-REFERENCE TO RELATED APPLICATIONS

This application claims the benefit of Canadian Patent Application 2,877,025, filed Jan. 9, 2015.

### FIELD

Embodiments taught herein relate to methods and apparatus for treating particulate materials and, more particularly, for treating proppants used for fracturing operations to hydrophobically modify the surfaces thereof.

### BACKGROUND

Sand slurries are used in a variety of industries, including but not limited to, petroleum, pipeline, construction and cleaning industries. One example where large amounts of sand slurry are used is hydraulic fracturing. Hydraulic fracturing of subterranean formations is used for increasing oil and gas production. In a hydraulic fracturing process, a fracturing fluid is injected into a wellbore for introduction into the subterranean formation at a pressure sufficient to initiate a fracture. Increased volumes of oil and gas flow through the fracture to the wellbore for enhancing production.

Fracturing fluid is flowed back to surface, generally at a last stage of a fracturing treatment. At least a portion of the proppant is left in the created fracture to prevent closure of the fracture after pressure is released. The proppant-filled fracture provides a highly conductive channel allowing oil and/or gas in the formation reach the wellbore more efficiently.

Frequently particulates, generally referred to as proppants, are suspended in the fracturing fluid, forming a slurry which is transported into the fracture. Proppants include, but are not limited to, sand, ceramic particles, glass spheres, bauxite (aluminum oxide), and the like. Sand has been the most commonly used proppant to date. Fracturing fluids in common use include various aqueous and hydrocarbon gels. Liquid carbon dioxide and nitrogen gas are also used in fracturing treatments. The most commonly used fracturing fluids are aqueous fluids containing cross-linked polymers or linear polymers to effectively transport proppants into formation.

The conductivity of the proppant in the fracture, referred to as the proppant-pack, plays a dominant role in increased transport of the oil and gas to the wellbore. It is well known however that the conductivity can be adversely affected, such as by polymer residues in the fracturing fluid, which greatly reduce the conductivity of the proppant-pack.

The density of sand is about 2.6 g/cm3 while the density of water is 1 g/cm3. The large density difference between sand and water causes sand to settle quickly in water, even under conditions of relatively high water turbulence. Once settled, sand is not easily lifted by the flow of the aqueous liquid from which it has settled.

Conventionally, sand has been suspended in a viscoelastic fluid to make a relatively stable slurry under static and/or dynamic conditions. In viscoelastic fluids, yield stress, which is the minimum shear stress required to initiate flow in a viscoelastic fluid, plays a dominant role in suspending the sand particles. The viscosity of the fluid acts to slow down the rate of particle settling, while the yield stress helps to suspend the particles. Under dynamic conditions, agitation or turbulence further helps to stabilize the slurry. Therefore, to cost-effectively prepare stable sand slurries, conventional methods have focused on manipulating the rheological properties of the fluid by adding sufficient amounts of viscosifier, for example, a natural or synthetic polymer, into the slurry. It is not unusual that a polymer is used together with a foaming agent to manipulate the rheology and reduce water usage, thereby reducing formation damage.

Flotation has been used in minerals engineering for the separation of finely ground valuable minerals from other solids, such as other minerals. Crude ore is ground to fine powder and mixed with water, collecting reagents and, optionally, frothing reagents. When air is blown through the mixture, hydrophobic mineral particles cling to the bubbles, which rise to form froth on the surface. The waste material (gangue) settles to the bottom. The froth is skimmed off. Water and chemicals are then removed from the froth, leaving a clean concentrate. The process, generally called froth flotation, is used for a variety of minerals.

The primary mechanism in froth flotation is the selective aggregation of micro-bubbles with hydrophobic particles under dynamic conditions to lift the particles to the liquid surface. The minerals and their associated gangue usually do not have sufficient hydrophobicity to allow bubbles to attach thereto. Hydrophobicizing agents, often referred to in the prior art as collecting agents, or collectors, are chemical agents that are able to selectively adsorb to desired minerals surfaces and make them hydrophobic to permit the aggregation of the particles and micro-bubbles and thus promote separation.

Frothers are chemical agents added to a slurry mixture to promote the generation of semi-stable froth. In a so-called “reverse flotation process”, the undesired minerals, such as silica sand in the froth are floated away from the valuable minerals which remain in the tailings. The reverse flotation of silica is widely used in processing iron as well as phosphate ores.

A wide variety of chemical agents are useful as hydrophobicizing agents and frothers for flotation of silica particles. Amines such as simple primary and secondary amines, primary ether amine and ether diamines, tallow amines and tall oil fatty acid/amine condensates are known to be useful for hydrophobicizing silica particles. It is well established that these chemical compounds strongly adsorb to sand surface and change the sand surface from hydrophilic to hydrophobic. In fact, the reason that these compounds are used is because of the ability to hydrophobicize the sand surface to allow the formation of stable sand/bubble aggregations. Preferred conventional hydrophobicizing agents are amine collectors having at least about twelve carbon atoms. Such hydrophobicizing agents are commercially available from, for example, Akzo Nobel of Amsterdam, Netherlands or Tomah Products Inc. of Milton. Wis. USA. Other possible hydrophobicizing agents are oleate salts which typically require the presence of multivalent cations such as Ca++ or Mg++ to work effectively.

Compounds generally useful as frothers in flotation include, but may not be limited to, low molecular weight alcohols including methyl isobutyl carbinol (MIBC) and glycol ethers.

By way of example only, U.S. Pat. Nos. 7,723,274 and 8,105,986 to Applicant, incorporated herein by reference in their entirety, have recognized that enhancing the transporting capability of particulates within a slurry is possible by rendering the particulate surfaces sufficiently hydrophobic to attach gas bubbles to particulate surfaces. Thus, the particulates are buoyed within the slurry and settling is minimized therein. Consequently, particulates such as proppants can be transported into the formation effectively without requiring the addition of viscosifiers to the fluid. Thus, the so-formed aqueous slurry can be used in various oilfield services, particularly in slickwater fracturing operations.

Different hydrophobicizing agents, including silicone compounds or hydrocarbon amines, as well as methods of preparing and using the slurry, are disclosed in U.S. Pat. No. 8,236,738; US Published Application 2014-0243245; U.S. Pat. No. 7,723,274; US Published Application 2010-0197526; U.S. Pat. No. 8,105,986; US Published Application 2012-0071371; US Published Application 2015-0252254 and Published Application US 2015-0307772.

Further, frothers, which act to stabilize bubbles can be added into the slurry. The most commonly used frothers are aliphatic alcohols, including particularly, methyl isobutyl carbinol (MIBC), 2-ethyl hexanol, n-pentanol, n-butyl, n-hexanol, 2-butanol, n-heptanol, n-octanol, isoamyl alcohol, polyethylene glycol, polypropyl glycol, as well as cyclic alcohols including pine oil, terpineol, fenchyl alcohol, alkoxy paraffins such as 1, 1, 3,-triethoxybutane (TEB) and polypropyl glycol ethers, such as commercial product DOWFROTH® available from Dow Chemical Company. It is understood that mixtures of the frothers, for example mixtures of the alcohols, are often used. As well, oils, including hydrocarbon oils such as mineral oils or paraffin oils and natural oils, can be used alone or in combination with, for example, an alcohol frother, to stabilize the bubbles on the particulate surfaces and enhance particulate agglomeration to improve proppant pack conductivity and oil/gas production. In all cases, a gas, such as nitrogen or carbon dioxide, is also typically added into the slurry.

In the prior art, where hydrophobicizing agents have been added to fracturing fluids for the purposes of hydrophobically modifying the proppants to enhance transport of the proppants within the fracturing fluids, the hydrophobicizing agents have been added into water, upstream of the blender tub and prior to the addition of the proppants and any other conventional frac fluid chemicals or to the slurry downstream of the blender tub. Thereafter, the gas, such as nitrogen, is normally added to the slurry and the slurry is pumped downhole.

These prior art methods may be limited as the efficacy of the hydrophobicizing agent to treat the proppant is compromised when added to the water stream or to the slurry as the hydrophobicizing agent may not efficiently contact the proppant surfaces. Conventionally, for this reason, the slurries have been over-treated with the hydrophobicizing agent to try to address the issue resulting in overusage of the hydrophobicizing agent. In this case, the relatively large residual portion of hydrophobicizing agent, which does not contact the poppant surface, remains in the water and may build up on flow meters and the like following use in fracturing operations.

Alternatively, proppants can be pre-treated, such as at a proppant or sand mining facility. The pre-treated proppant is then delivered to sand storage. There are some issues with this approach as well, including but not limited to, obtaining supply of product on time, holding and storing inventory of the product, shipping the product over large distances and/or being required to have facilities near operating areas to obtain product. Further, in order to obtain proppants coated with specific additives, a supply of additive would also have to be shipped to the supplier for custom-treatment of the proppant.

There is interest in the various industries, and particularly in the oil and gas industry, for apparatus and methods for treating of particulates, such as proppants, that are more efficient and cost effective.

### SUMMARY

Embodiments taught herein are used for the preparation of a proppant slurry wherein the proppants are treated on-the-fly with an additive, prior to the proppants coming into contact with other components of the slurry. In the case of a fracturing fluid, the proppant, such as sand, is treated with hydrophobicizing agent to hydrophobically modify the sand to render surfaces of the sand hydrophobic while the sand is substantially dry. The modified proppant is thereafter blended with a fluid component, such as water, for forming the proppant slurry to be used, for example, in a fracturing operation. The addition of the hydrophobicizing agent directly to the dry proppant on-the-fly allows for the optimization of the interaction between the proppant and hydrophobicizing agent. The optimization results in lower hydrophobicizing agent utilization, lower cost and reduced environmental impact such as dust suppression on site.

In a broad aspect, apparatus, adapted for use with one or more inclined augers supplying proppant to a blender tub for mixing the proppant with a liquid for preparing a proppant slurry, comprises: one or more main spray nozzles mounted above a discharge end of each of the one or more inclined augers so as to distribute an additive to substantially dry proppant discharging to fall from the discharge end of the auger into the blender tub. The one or more main spray nozzles distribute the additive generally in a direction of fall of the discharging proppant.

In embodiments one or more auxiliary spray nozzles are mounted adjacent the discharge end of the auger and protrude into the discharging proppant. The one or more auxiliary spray nozzles distribute the additive within and beneath the proppant.

Further, in embodiments, one or more spray orifices are also mounted adjacent the discharge end of the auger. The one or more spray orifices distribute the additive into the proppant substantially perpendicular to the direction of fall of the proppant.

The main and auxiliary nozzles form spray patterns, the nozzles being spaced so as to overlap the spray patterns from adjacent nozzles for optimizing delivery of the additive to the proppant.

In another broad aspect, a method for forming a proppant slurry on-the-fly comprises: lifting a substantially dry proppant above a blender tub for falling therefrom into the blender tub. An additive is distributed onto the falling proppant, generally in a direction of fall of the proppant for distributing the additive onto the proppant surfaces forming a modified proppant. Thereafter liquid is introduced into the modified proppant for mixing therewith for forming the slurry.

In embodiments, the additive is distributed by spraying onto the proppant. The spraying is generally in the direction of fall of the proppant and is from above the falling proppant. The spraying can also be from within and beneath the falling proppant.

Where the slurry is used for fracturing, the additive is distributed in an amount relative to loading of the proppant and a pumping rate of the slurry into a wellbore. Further, the additives are selected to be compatible with the liquid and any additional additives added to the slurry.

In embodiments wherein the slurry is used for fracturing and the additive is a hydrophobicizing agent, the hydrophobicizing agent is distributed from about 0.1 L to about 40 L per metric tonne of proppant. In embodiments, the hydrophobicizing agent is distributed from about 2 L to about 20 L per metric tonne of proppant.

In embodiments wherein the slurry is used for fracturing, the additive is a hydrophobicizing agent and the proppant loading is from about 0.01 kg/m³ to about 2200 kg/m³, the hydrophobicizing agent is distributed to the proppant at about 0.1 L/min to about 300 L/min.

### BRIEF DESCRIPTION OF THE DRAWINGS

FIG. 1 is a fanciful side view of a prior art inclined auger for use on a fracturing blender, such as mounted at a rear of a truck, for lifting proppant from a hopper and from which the proppant falls from a top discharge end of the inclined auger into a blender tub on for mixing with a fluid medium, such as for forming a fracturing fluid, auger flights being shown in dotted lines and portions of the hopper and truck having been removed for clarity;

FIG. 2A is a side view of an embodiment of a spray-setup taught herein illustrating spray nozzles operatively connected to an inclined auger for distributing a chemical additive to proppant as it is discharging therefrom, details of the truck, onto which the inclined auger and a hopper for supplying the proppant are mounted, having been minimized for clarity;

FIG. 2B is an enlarged partial side view, according to FIG. 2A, of an embodiment taught herein having one or more main spray nozzles mounted above the discharge end of the inclined auger for distributing the chemical additive to proppant as it is discharging from the inclined auger;

FIG. 2C is an enlarged side view, according to FIG. 2B, of an embodiment further comprising auxiliary spray nozzles mounted adjacent and below the discharge end of the auger, the nozzles protruding upwards into the discharging proppant for further distributing the chemical additive to the proppant as it is discharging from the inclined auger;

FIG. 2D is an enlarged side view, according to FIG. 2C, of an embodiment further comprising spray orifices mounted adjacent and below the discharge end of the auger, the orifices further distributing the chemical additive to the proppant as it is discharging from the inclined auger and further detailing angles of spray of each of the main and auxiliary nozzles and the spray orifices;

FIG. 2E is a plan view according to FIG. 2A illustrating an embodiment having more than one inclined auger supported on the rear of the truck;

FIGS. 3A-3F are representations illustrating nozzle spray patterns usable in embodiments taught herein, more particularly;

FIG. 3A illustrates a flat fan spray pattern for convex distribution;

FIG. 3B illustrates a flat fan spray pattern for even distribution;

FIG. 3C illustrates a full cone spray pattern for convex distribution;

FIG. 3D illustrates a full cone spray pattern for even distribution;

FIG. 3E illustrates a hollow cone spray pattern for concave distribution; and

FIG. 3F illustrates a straight spray pattern for single point distribution;

FIG. 4 is a plan view of the discharge end of the inclined auger illustrating a spray bar having the one or more spray orifices formed therein and to which the auxiliary spray nozzles are mounted;

FIG. 5 is an enlarged partial side view, according to FIG. 2A, illustrating a partial funnel extending from adjacent the discharge end of auger to the blender tub for ensuring sand falling therefrom is directed to the blender tub; and

FIG. 6 is a fanciful illustration of manifolding used for delivery of additive to the main and auxiliary nozzles and to the spray orifices.

### DETAILED DESCRIPTION

While Applicant is aware that pre-treating of proppant can be achieved off-site, such as at mining facilities, pre-treatment may present issues, including but not limited to, obtaining supply of product on time, holding and storing inventory of the product, shipping the product over large distances and/or being required to have facilities near operating areas to obtain product. Further, in order to obtain proppants treated with specific additives, a supply of additive would also have to be shipped to the supplier for custom-treatment of the proppant. Where different additives may be selected for each operation based upon a variety of factors, such as the water in which the fracturing fluid is prepared, the chemicals required in the fracturing fluid, the well conditions and the like, a service company may have to purchase and store many different pre-coated proppants.

Historically, as previously noted, preparing a proppant slurry for fracturing operations and treatment of proppants therein, on-the-fly, has been performed by adding the additive, a hydrophobicizing agent, directly to the liquid, typically water, either at the upstream, suction side of the blender or at the downstream, discharge side of the blender. The slurry was then allowed to mix in the plumbing of the surface pumping equipment. Often, the additive was over-delivered to compensate for the fact that a certain portion of the additive would remain in the water and was unable to adsorb to the surface of the proppant.

Unlike the historical approach described above, embodiments taught herein spray the additive directly onto substantially dry proppant, on-the-fly, before the proppant is added to the liquid, which typically contains any additional, conventional frac fluid additives. Thus, the interaction between the proppant and additive is optimized, resulting in lower additive utilization, lower cost, reduced environmental impact and lowered operational costs.

Embodiments taught herein are particularly suitable for on-the-fly treatment of proppant particles with hydrophobicizing agents for hydrophobically modifying surfaces of the proppant and for forming aqueous fracturing fluid slurries. Substantially dry proppant particles are contacted with the hydrophobicizing agent, prepared in water, prior to contact with any other chemicals, fluids or the like. The hydrophobicizing agent is selected for its ability to hydrophobically modify the proppant as well as its compatibility with other chemicals or fluids in the fracturing fluid and/or with specific wellbore and formation characteristics. Treatment on-the-fly thereby eliminates the need to prepare and store a variety of proppants coated with different hydrophobicizing agents and to transport a specific proppant to a specific well site.

In embodiments, the proppant is contacted with the additive when the proppant, typically sand, is substantially dry. “Substantially dry” is intended to mean having amounts of water or other liquid associated therewith that permit an economically significant reduction in the amount of additive necessary to ensure sufficient hydrophobic modification of the surfaces of the proppant to achieve stable sand/bubble aggregations for forming the proppant packs within the fractures. Further, the substantially dry proppant is flowable, so as to be stored in silos, sand hogs and the like and conveyable for delivery to hoppers and to be lifted by augers.

Embodiments taught herein provide a simple operational and cost effective apparatus and process for hydrophobically modifying proppant surfaces for making aqueous slurries for hydraulic fracturing operations. Over-treatment to ensure adequate surface modification is thereby minimized or eliminated, reducing the amount of additive required.

### Spray Set-Up

Embodiments taught herein are described in the context wherein the proppant is sand P, the liquid is water W and the additive A is a hydrophobicizing agent. This is in no way intended to limit embodiments taught herein to use this specific context. As one of skill will appreciate, embodiments taught herein are applicable to a variety of proppants whose surfaces can be treated or modified prior to use as well as to a variety of additives which may be used to treat proppant and to a variety of liquid in which a proppant slurry can be prepared.

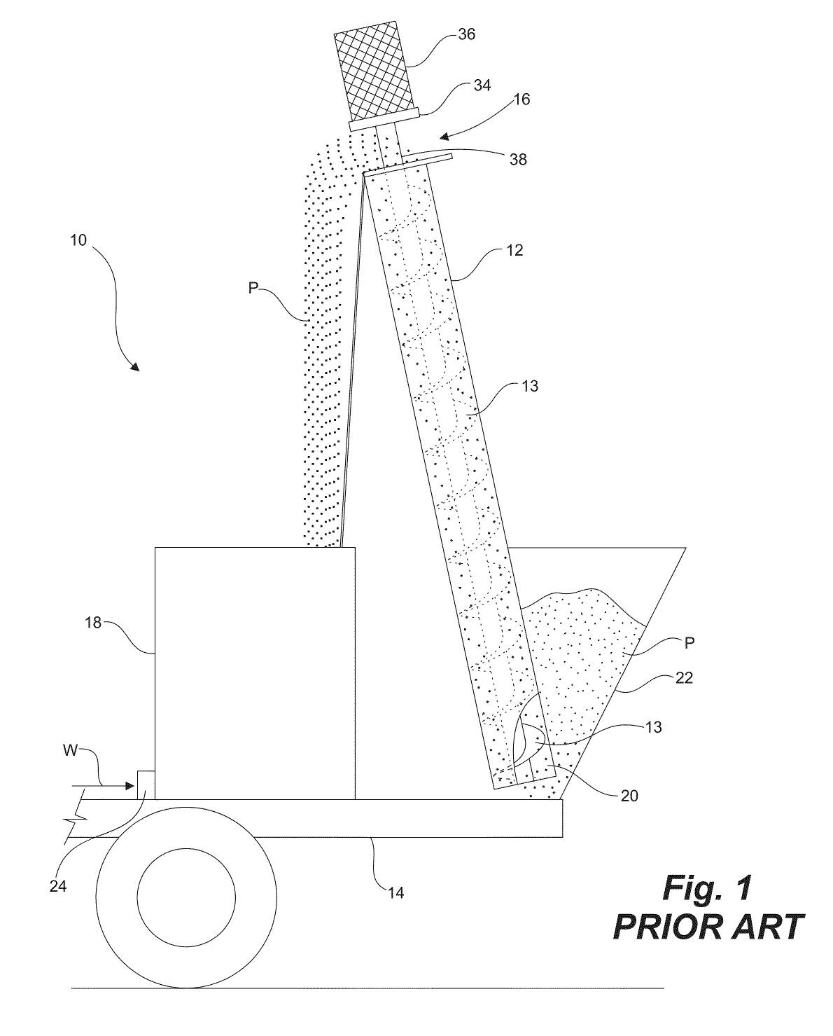

Having reference to FIG. 1, a prior art blender truck 10 generally comprises one or more inclined augers 12, which have internal flighting 13, mounted at a rear 14 thereof at an angle, such as about 80°, for positioning an upper discharge end 16 above a blender tub 18 and a lower intake end 20 into a hopper 22, generally also mounted to the rear 14 of the truck 10. The one or more inclined augers 12 lift and deliver the proppant or sand P from the hopper 22 to the upper discharge end 16 of the auger 12 located above the blender tub 18. Sand P, piling at the top of the inclined auger 12, falls therefrom into the blender tub 18, generally by gravity. Water W, or other suitable liquid, is fed through piping 24, mounted on the truck 10, to the blender tub 18 for mixing with the sand P and forming the slurry S therein. Conventional fracturing fluid additives or chemicals, including but not limited to, one or more of polymers, clay control additives, surfactants for reducing surface tension and preventing or minimizing emulsions, scale control additives, corrosion inhibitors, biocides, pH control, breakers and the like, are typically added to the water W upstream of the blender tub 18 or to the slurry S downstream of the blender tub 18.

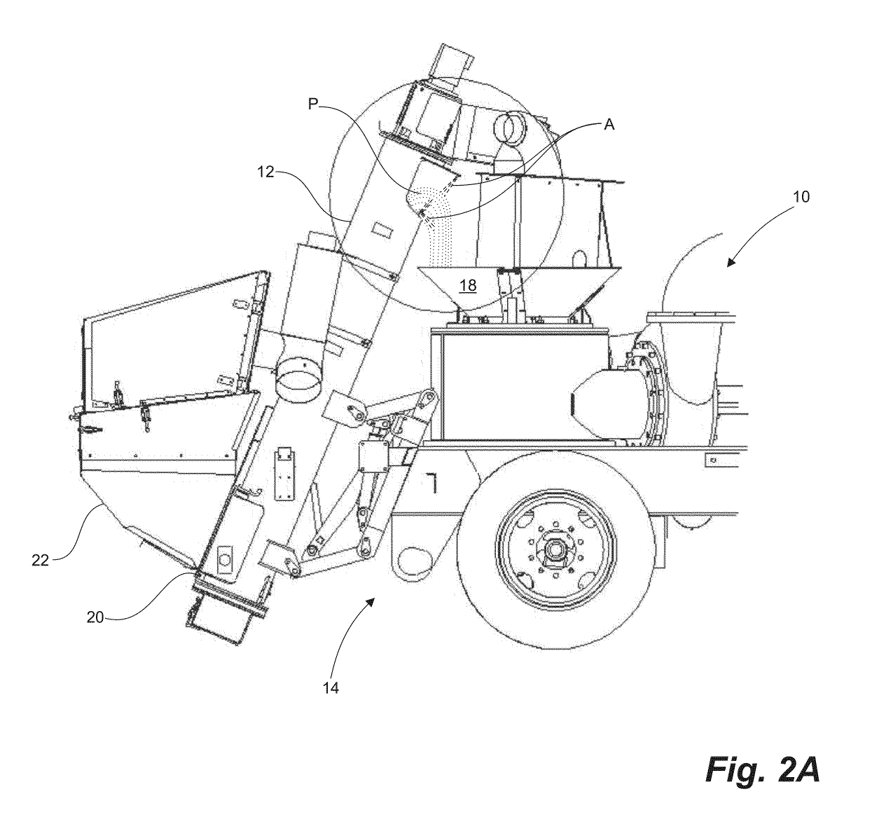

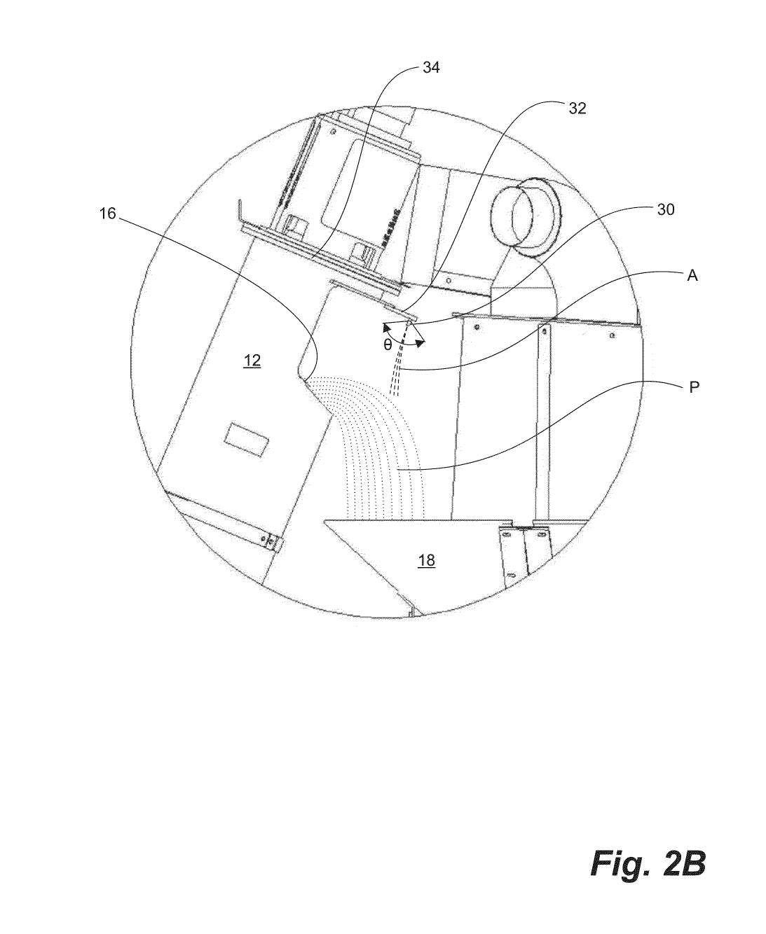

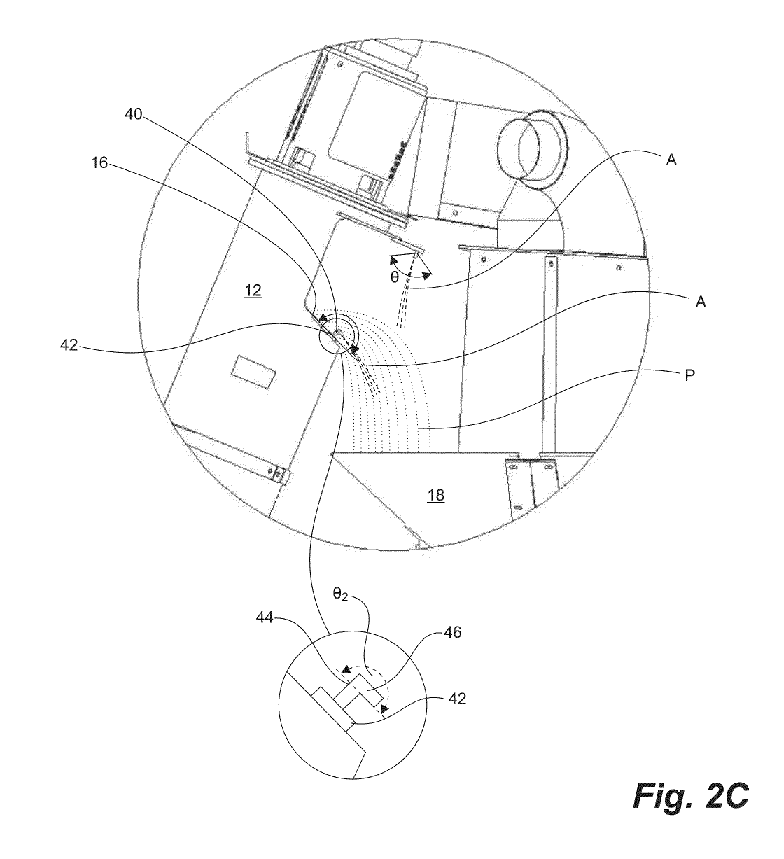

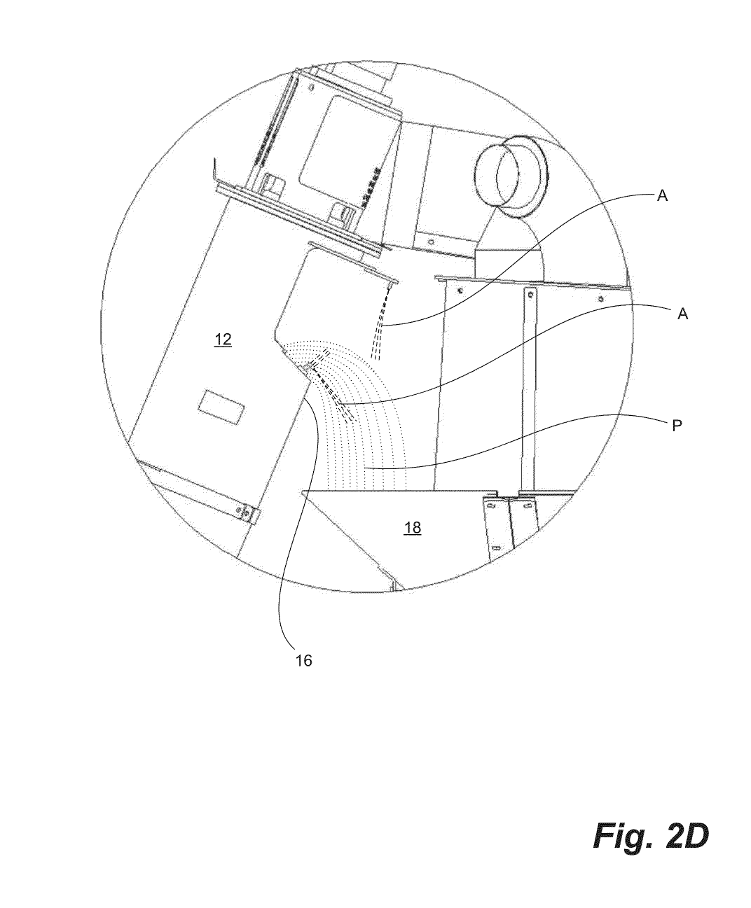

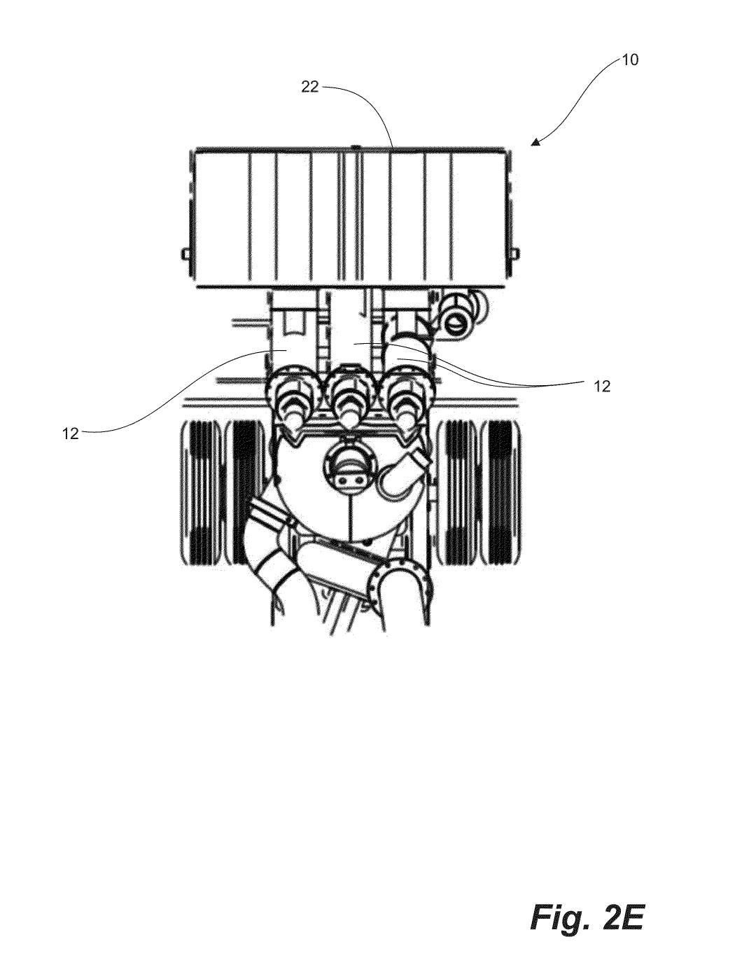

Having reference to FIG. 2A, in embodiments taught herein, one or more hydrophobicizing agents A for hydrophobically modifying surfaces of the sand P are sprayed onto the falling sand P generally in a direction of fall of the falling sand P for distributing the hydrophobicizing agent A thereon to treat surfaces of the sand P therewith, prior to the sand reaching the blender tub 18. Hydrophobicizing agent A may also be sprayed into the falling sand P to optimize contact between the proppant surfaces and the hydrophobicizing agent A.

In an embodiment, as shown in FIG. 2B, the hydrophobicizing agent A is sprayed onto the falling proppant P from above the discharge end 16 of the inclined auger 12 and in the direction of fall of the sand.

In another embodiment, as shown in FIG. 2C, the hydrophobicizing agent A is also sprayed onto the sand P from beneath and within the falling sand P, and generally parallel to the direction of fall, to further distribute the hydrophobicizing agent A onto the surfaces of the sand P.

In yet another embodiment, as shown in FIG. 2D, the hydrophobicizing agent A is also sprayed onto the sand P from beneath the falling sand and generally perpendicular to the direction of fall of the sand.

More particularly, with reference again to FIGS. 1, 2B to 2D, in an embodiment, one or more main nozzles 30 are supported above the discharge end 16 of each of the one or more augers 12, such as to a mounting plate 32 extending outwardly from the auger 12 or from a flange 34 which supports a motor 36 for driving a shaft 38 of each of the one or more augers 12, located thereabove.

As shown in FIGS. 2B to 2D, the one or more main nozzles 30 are mounted, such as to the mounting plate 32, offset from an axis X of the auger 12. The main nozzles 30 spray the hydrophobicizing agent A, generally in a spray pattern as discussed below, at an angle θ from about 45° to about 135° to the mounting plate 32 and transverse to the flow of sand P exiting the discharge end of the auger 12. The spray is generally in the direction of fall of the sand P. When viewed from the side, such as in FIG. 2B, the spray pattern extends into and out of the page, the arrows showing the angle at which the spray pattern can be directed. In embodiments, the angle θ is about 90°.

In embodiments, wherein two or more main nozzles 30 are used, the two or more main nozzles 30 are spaced such that the spray from one main nozzle 30 typically overlaps the spray from the adjacent main nozzles 30 for optimizing distribution of the hydrophobicizing agent A to the sand P. As will be appreciated, spacing between the nozzles 30 can be adjusted for overlapping of the spray therefrom dependent upon at least the size and/or the shape of the spray pattern to extend across substantially all of the transverse extent of the sand P as it exits the auger 12.

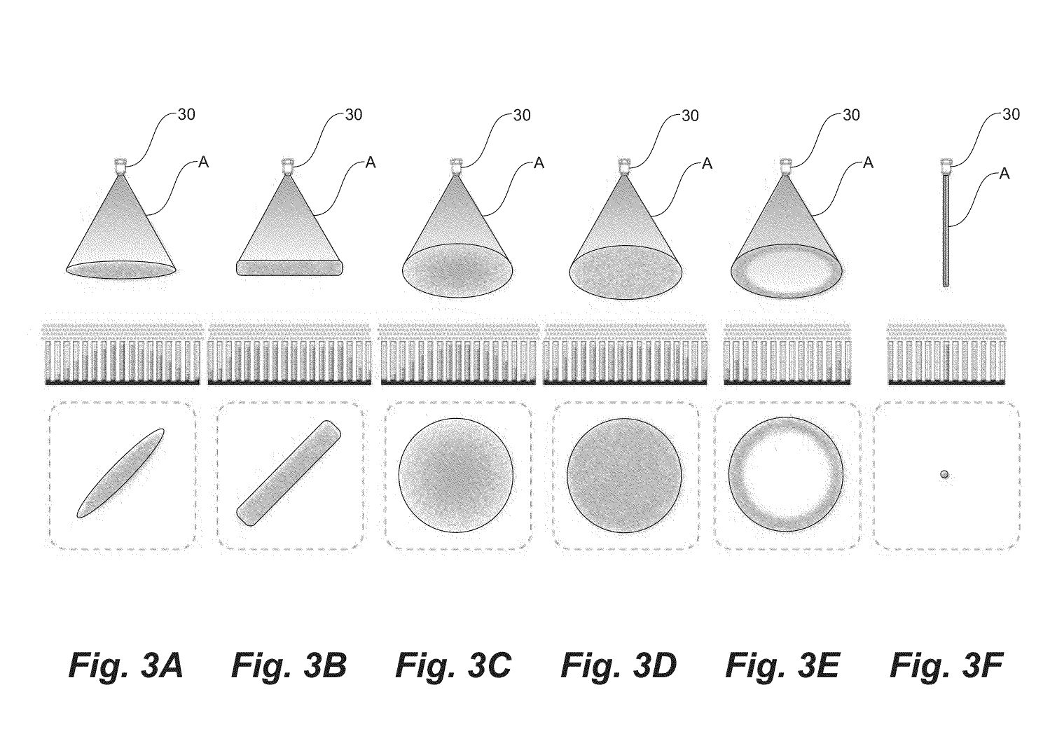

Having reference to FIGS. 3A-3F, in embodiments, each of the one or more main nozzles 30 forms a spray pattern which distributes the hydrophobicizing agent A onto the sand P.

In embodiments, the spray pattern is the flat fan pattern for even distribution (FIG. 3A) or convex distribution (FIG. 3B).

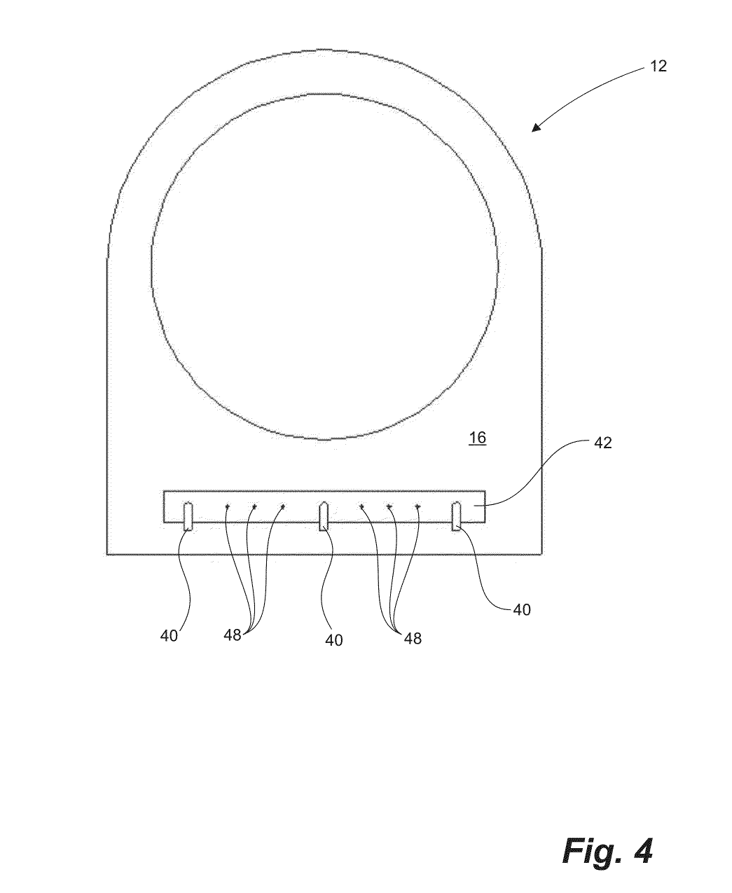

Having reference to FIGS. 2C and 4, in embodiments one or more auxiliary nozzles 40, are mounted adjacent the discharge end 16 of the auger 12, such as to a spray bar 42 supported downstream from the discharge end 16 of the auger 12. In embodiments, the one or more auxiliary nozzles 40 are mounted to the spray bar 42. As shown, the spray bar 42 can be mounted directly onto the auger 12.

The auxiliary nozzles 40 have a first portion 44 which extends outwardly from the spray bar 42 and have a second portion 46 which extends therefrom. The spray can be directed at an angle θ2 from about 0° to about 180° relative to the spray bar 42 to distribute the hydrophobicizing agent A onto the sand P and generally in the direction of fall of the sand P. The auxiliary nozzles 40 generally protrude upwardly into the sand P as the sand P begins to fall from the discharge end 16 of the auger 12 into the blender tub 18. In embodiments the hydrophobicizing agent A is sprayed generally parallel to the direction of the fall of the sand P. In embodiments the spray from the auxiliary nozzles 40 is directed at about a 90° angle relative to the hydrophobicizing agent A being sprayed from the one or more main nozzles 30.

Having reference to FIGS. 2D and 4, in embodiments, the spray set-up further comprises one or more spray orifices 48 formed in the spray bar 42. The spray orifices 48 further distribute the hydrophobicizing agent A into the sand P, delivering the hydrophobicizing agent A substantially perpendicular to the spray bar 42 and into the sand P.

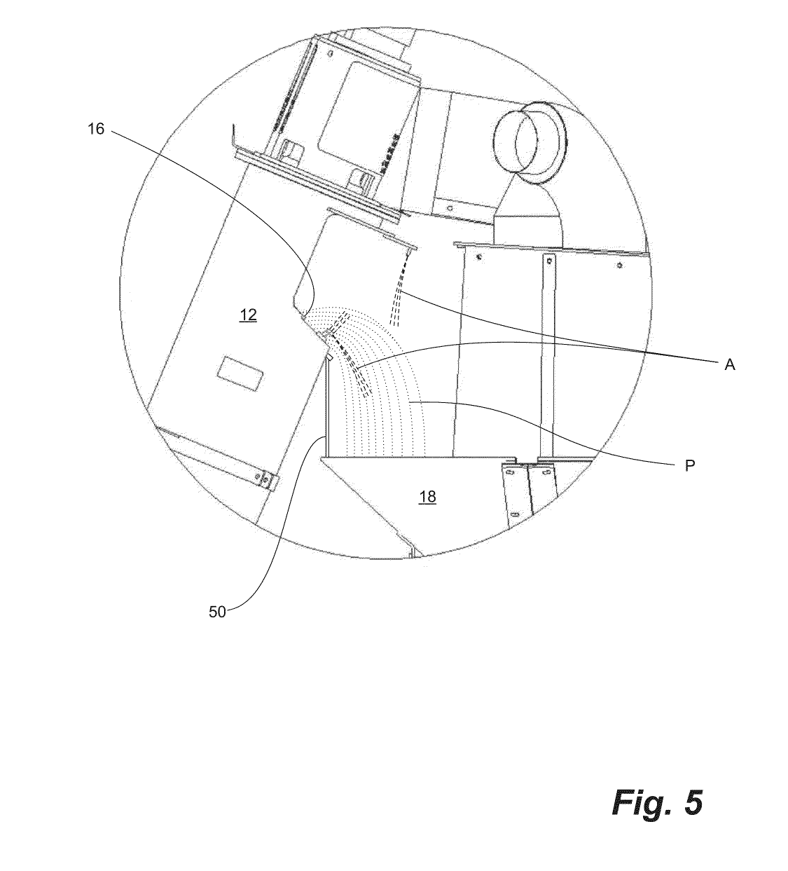

In embodiments, as shown in FIG. 5, apparatus, such as flexible skirting, is operatively supported from adjacent the discharge end 16 of the auger 12 to the blender tub 18 for forming at least a partial funnel 50 for ensuring the falling sand P is directed into the blender tub 18, during and after contact with the hydrophobicizing agent A. In embodiments, the flexible skirting 50 is bolted to the auger 12 below the discharge end 16 and extends therefrom into the blender tub 18.

Having reference to FIG. 2E, where greater loading of sand P is required, typically more than one auger 12 is provided on the blender truck 10. As in conventional proppant slurry production, fewer or greater of the one or more augers 12 are in use at any given time depending upon the rate of sand delivery required to meet the operational needs. Where sand loading is at or near capacity of a single auger 12, more than one auger 12 is typically used to avoid overworking the single auger 12. Each of the one or more augers 12 is fit with a spray set up as described herein.

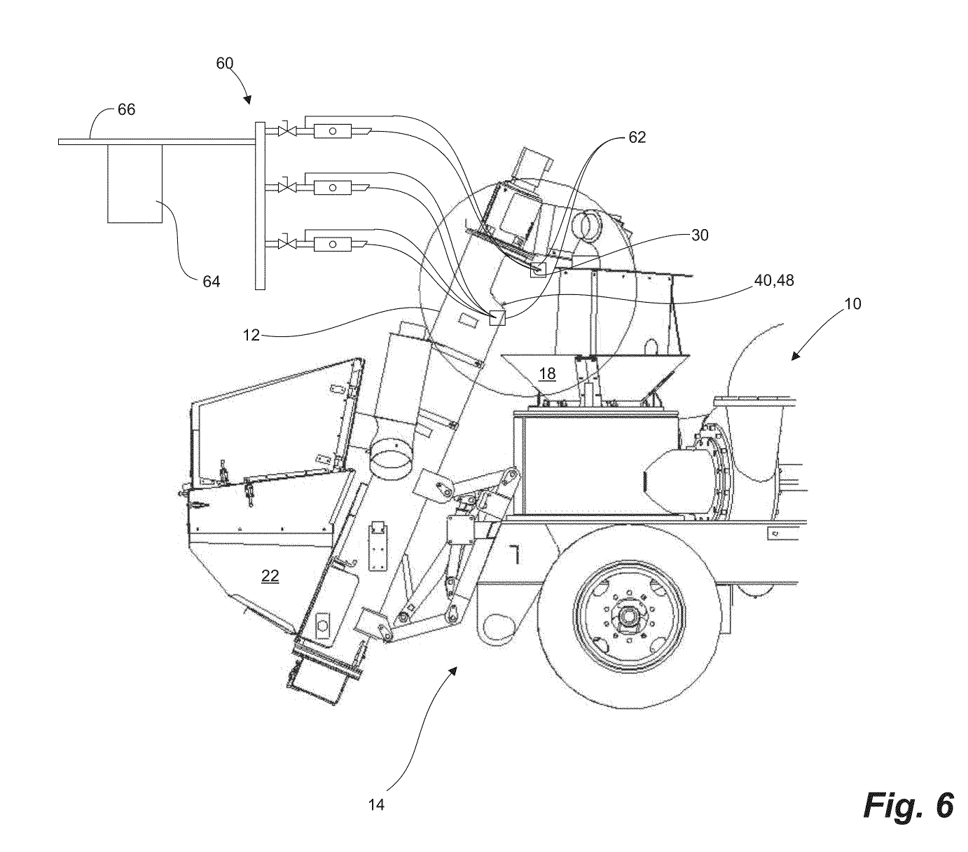

In embodiments, having reference to FIG. 6, manifolding 60 is incorporated into a conventional blender set-up for delivering the hydrophobicizing agent A to the main nozzles 30, the auxiliary nozzles 40 and the spray orifices 48. The flow rate of the hydrophobicizing agent A to either or both of the main nozzles 30 and to the auxiliary nozzles 40 and spray orifices 42 can be selectively altered through the manifolding 60. Camlock fittings 62 allow for quick connection of standard chemical hose, typically used on a conventional chemical van, fluidly connected to the main and auxiliary nozzles 30, 40 and to the spray bar's spray orifices 48. The hydrophobicizing agent A is metered relative to the rate of sand delivery to achieve a desired ratio of hydrophobicizing agent A to sand P and at a rate to meet the overall operational needs of the fracturing operation. A filter 64 is incorporated into a hydrophobicizing agent supply line 66 to minimize debris and plugging of the spray apparatus. Hydrophobicizing agent A is delivered at a pressure sufficient to create a spray at the nozzles and orifices.

In cases, where some of the one or more main or auxiliary spray nozzles 30, 40 or spray orifices 42 are not required, certain of the nozzles 30,40 or orifices 48 can be taken out of service by plugging. Additional nozzles 30,40 or orifices 48 can also be added, depending upon the system requirements.

In embodiments, the hydrophobicizing agent A is added at a rate in the range from about 0.1 L/metric tonne of sand P to about 40 L/metric tonne of sand P. In embodiments of on-the-fly applications, the rate generally varies from about 2 L/metric tonne of sand P to about 20 L/metric tonne of sand P. Applicant believes that embodiments taught herein result in a significant reduction in the amount of hydrophobicizing agent A used compared to prior art processes wherein the hydrophobicizing agent A was added to the water W upstream of the blender tub 18 or was added to the slurry S downstream of the blender tub 18. Reductions by as much as about ⅓ of the amounts used in the prior art have been observed, as shown in testing data provided below.

Further, in embodiments, the system is typically operable from about 0.1 psi to about 2000 psi to create the spray from the main and auxiliary nozzles 30,40 suitable to coat the falling sand P with the hydrophobicizing agent A. The system however has been designed such that operating pressures are not limiting. Exemplary pressures are generally from about 10 psi to about 200 psi.

In embodiments, application rates of hydrophobicizing agent A for on-the-fly operations are typically from about 0.1 L/min to about 300 L/min using sand slurry concentrations from about 0.01 kg/m³ to about 2200 kg/m³.

### Testing and Comparison Data

### Lab Testing of Performance of Spray Proppant Treatment Compared to Conventional Proppant Treatment

Performance of Hydrophobicization

Slick water systems comprising 250 kg/m³ to 1000 kg/m³ of sand for each of 40/70, 30/50 and 20/40 mesh sand were prepared according to conventional methodology and according to embodiments taught herein. Each of the systems also contained 2 L/m³ of a clay control additive and 1 L/m³ of a friction reducer.

The systems prepared using conventional on-the-fly methodologies were prepared as follows:
add 200 mL tap water to a bench-top lab blender;
inject 0.4 mL of a hydrophobicizing agent to the water in the blender;
add untreated sand to the blender according to Table A below while mixing at moderate speed;
inject 0.4 mL of the clay stabilizer into the blender;
inject 0.2 mL of the friction reducer into the blender and continue to blend at high speed for 20 seconds; and
stop and record sand floating status as an indicator of hydrophobicization.

The systems prepared according to embodiments taught herein were prepared as follows:
pre-treat sand with the hydrophobicizing agent alone;
add 200 mL tap water to a bench-top lab blender;
inject 0.4 mL of the clay stabilizer into the blender and 0.15 mL of an additive to assist sand floating into the blender while mixing at moderate speed;
add the pre-treated sand while mixing at moderate speed;
inject 0.2 mL of a friction reducer into the blender and continue to mix at high speed for 20 seconds; and
stop and record sand floating status as an indicator of hydrophibicization.

TABLE A

| | Sand - spray treatment | | | Sand - conventional | |
|---|---|---|---|---|---|
| | Sand | | % volume | | % volume |
| | concen- | | increase | | increase |
| Mesh | tration | % floating | compared | % floating | compared |
| rating | (kg/m3 | on top | to control | on top | to control |
| of sand | water) | of water | sand | of water | sand |
| 20/40 | 250 | 80-90 | — | 5 | — |
| | 500 | 70-80 | — | 5 | — |
| | 750 | 50-60 | — | 5-10 | 10 |
| | 1000 | 5 | 64 | 5-10 | 7 |
| 30/50 | 250 | 100 | — | 5 | — |
| | 500 | 40 | — | 0 | — |
| | 750 | 5 | 185 | 5-10 | 10 |
| | 1000 | 5-10 | 96 | 5 | 11 |
| 40/70 | 250 | 100 | — | 90 | — |
| | 500 | 70 | — | 40-50 | — |
| | 750 | 0 | 195 | 20 | 20 |
| | 1000 | 0 | 96 | 5 | 14 |

The results demonstrate that the slurry, prepared according to embodiments taught herein, using the pretreated sand performs better than the slurry prepared using the conventional on-the-fly method, particularly for the coarser, less easily suspended sand (20/40 and 30/50 sand). The concentration of the sand appears to have a significant effect on sand floating, wherein when sand concentration is low the sands tend to float on top of the water, whereas with increasing sand concentration, the sand mass tends to suspend within the water rather than floating on top. Although sand in both the pre-treated and conventional on-the-fly slurries agglomerate having significantly larger volume than untreated sand, the embodiments taught herein generally result in a larger agglomeration volume than the conventional methodology.

Further, Applicant believes that the addition of the other chemical additives can be to ether the suction side or the discharge side of the blender tub without significantly altering the performance of slurries prepared using embodiments taught herein.

Salt Tolerance/Compatibility

Floating as a result of hydrophobicization of the sand was evaluated for slurries prepared in salt water according to embodiments taught herein and in conventional on-the-fly slurries. Different salt concentrations were prepared for KCl, CaCl₂, and MgCl₂. The sand concentration was fixed at 250 kg/m³ for different mesh size sand. The results are shown in Table B below:

TABLE B

| | Flotation of pretreated sand | | | Flotation of conventionally treated sand | | |
|---|---|---|---|---|---|---|
| Salt and | Sand mesh | | | | | |
| concentration | 20/40 | 30/50 | 40/70 | 20/40 | 30/50 | 40/70 |
| 3% KCl | 100% | 100% | 100% | 70-80% | 100% | 100% |
| | | | | unstable | unstable | |
| 5% KCl | — | — | — | 50-60% | 70-80% | 100% |
| | | | | unstable | unstable | |
| 7% KCL | 100% | 100% | 100% | 50-60% | 70% | 100% |
| | | | | unstable | unstable | unstable |
| 10% KCl | 100% | 100% | 100% | 5% | 100% | 100% |
| | unstable | | | | unstable | unstable |
| 15% KCl | 100% | 100% | 100% | — | 100% | 100% |
| | very | | | | unstable | unstable |
| | unstable | | | | | |
| 0.75% CaCl₂ | 100% | 80-90% | 100% | 15% | 80% | 100% |
| (2700 ppm Ca²⁺) | | | | unstable | unstable | |
| 1.5% CaCl₂ | 90% | 90% | 100% | 10% | 70% | 100% |
| (5400 ppm Ca²⁺) | | | | unstable | unstable | unstable |
| 10% CaCl₂ | 70% | 100% | — | 5% | 70% | 80-90% |
| (36000 ppm Ca²⁺) | | | | | unstable | |
| 0.94% MgCl₂ | 100% | 100% | 100% | 10% | 70% | 100% |
| (2375 ppm Mg²⁺) | | | | | | |
| 10% MgCl₂ | 80% | 100% | — | 5% | 50% | 90% |
| (25260 ppm Mg²⁺) | | | | | unstable | |

According to the bench testing, slurries prepared using sand treated according to embodiments taught herein can be prepared in water having KCl up to about 10% whereas conventional on-the-fly slurries became less efficient when KCL concentration reached about 7%. Both slurries tolerated high concentrations of Ca²⁺ and Mg²⁺ however those prepared using embodiments taught herein appear to perform better. Overall therefore, it appears that sand, treated using embodiments taught herein, is more efficient in brackish and salt water than sand treated using conventional on-the-fly methods.

In another bench test, a silicone-based hydrophobicization agent was tested for flotation performance and/or volume increase, salt tolerance and the effect of pH, when slurries were prepared according to embodiments taught herein. The concentration of 20/40 sand was kept constant at 300 kg/m³ and the hydrophobicizing agent was tested at 0.5% and 0.7% v/w based on the sand.

The slurries were prepared as follows:
mix sand with the hydrophobicizing agent thoroughly to coat;
pour coated sand into water in a blender running at moderate speed;
inject 1 L/m³ of a friction reducer into the blender running at moderate speed;
stop blender to observe proppant flotation.

Applicant observed that in both the 0.5% and 0.7% v/w slurries formed the desired suspensions.

Salt Tolerance/Compatibility

Further, the 0.5% and 0.7% v/w of sand slurries as described above were also prepared in water containing different concentrations of salts as shown in Table C below:

TABLE C

| | | | Sand flotation % | |
|---|---|---|---|---|
| Salt and | Cation | Anion | Slurry at | Slurry at |
| concentration | ppm | ppm | 0.5 mL/100 g | 0.7 mL/100 g |
| 0 | — | — | 100 | — |
| 10% KCl | 52384 | 47615 | 90 | — |
| 10% CaCl₂—2H₂O | 27229 | 48299 | 90 | — |
| 10% MgCl₂—6H₂O | 11828 | 34975 | 90 | — |

While salinity affects sand flotation, with respect to different salts such as KCl, CaCl₂ and MgCl₂, the 0.5% v/w slurry generally demonstrated excellent performance.

### Water Quality

Applicant is aware that poor quality water, such as from the Marcellus Shale formation demonstrates reduced efficiency of the sand suspension when used to prepare slurries on-the-fly according to conventional methods.

Slurries were prepared using Marcellus water, known for its very poor quality, according to embodiments taught herein as shown in Table D below:

TABLE D

| | Sand flotation % | |
|---|---|---|
| Sand mesh | 250 kg/m3 | 750 kg/m3 |
| 20/40 | 95 | 70 on top |
| | | bottom sand fluffy |
| 30/50 | 100 | 20 on top |
| | | bottom sand fluffy |

As shown, slurries prepared according to embodiments taught herein have improved tolerance for poor quality water than has previously been found for slurries prepared on-the-fly using conventional methodologies.

### Reduction in Usage of Hydrophobicizing Agents

Slurries were prepared using 150 g of 20/40 sand, provided by Sil Industrial Minerals of Edmonton, Alberta, Canada and using silicon-based hydrophobicizing agents A and B at different concentrations, diluted in isopropyl alcohol (IPA), as shown in Table E below.

Different amounts of the hydrophobicizing agents were mixed with 18 mL of well water provided by Sil Industrial Minerals, were added to sand and mixed and were thereafter dried at 60°, instead of spraying on-the-fly, to test embodiments taught herein.

TABLE E

| | | Hydropho- | | |
|---|---|---|---|---|
| | Hydropho- | bicizing | | |
| | bicizing | agent Kg | | |
| Sand | agent and | consumed per | Flotation | Slurry |
| mesh | concentration | tonne sand | of sand % | stability |
| 20/40 | A at 20% in IPA | 0.34 | 95 | Stable |
| | | 0.31 | 90 | Stable |
| | | 0.28 | 90 | Stable |
| | | 0.25 | 80 | Stable |
| 20/40 | B - neat | 0.34 | 80 | Stable |
| | | 0.31 | 85 | Stable |
| | | 0.28 | 85 | Stable |
| | | 0.25 | 50-60 | Stable |
| 20/40 | B at 15% in IPA | 0.34 | 90 | Stable |
| | | 0.31 | 80 | Stable |
| | | 0.28 | 80 | Stable |
| | | 0.25 | 80 | Stable |
| 20/40 | B at 10% in IPA | 0.34 | 80 | Stable |
| | | 0.31 | 80 | Stable |
| | | 0.28 | 95 | Stable |
| | | 0.25 | 80 | Stable |

Hydrophobicizing agent A, at 20% in IPA performs slightly better than hydrophobicizing agent B. Lower concentrations of hydrophobicizing agent B however provided acceptable results.

Further testing for reduction in chemical usage was performed, using the same set-up as described above, for 20/40, 30/50 and 40/70 sand and hydrophobicizing agent B. Slurries were prepared in clean water however for each grade of sand at least one slurry was prepared in poor quality Marcellus water to determine the effect thereof.

The results are shown in Table F below:

TABLE F

| | | Hydropho- | | |
|---|---|---|---|---|
| | Hydropho- | bicizing | | |
| | bicizing | agent Kg | Flota- | |
| Sand | agent and | consumed per | tion of | Slurry |
| mesh | concentration | tonne sand | sand % | stability |
| 20/40 | 0.21 mL B - neat | 0.25 | 80 | Stable |
| | 0.25 mL B -15% in IPA | 0.21 | 95 | Stable |
| | 0.2 mL B -15% in IPA | 0.14 | 90 | Stable |
| | 0.15 mL B - 15% in IPA | 0.13 | 60 | Stable |
| | 0.15 mL B - 15% in IPA* | 0.13* | 50* | Stable* |
| | 0.1 ml B - 15% in IPA | 0.085 | 30 | Stable |
| 30/50 | 0.3 mL B - neat | 0.34 | 100 | Stable |
| | 0.25 mL B - neat | 0.23 | 100 | Stable |
| | 0.45 mL B -15% in IPA | 0.32 | 95 | Stable |
| | 0.35 mL B -15% in IPA | 0.245 | 100 | Stable |
| | 0.2 mL B -15% in IPA | 0.14 | 90 | Stable |
| | 0.2 mL B -15% in IPA* | 0.14* | 70* | Stable* |
| | 0.1 mL B -15% in IPA | 0.07 | 80 | Stable |
| | 0.1 mL B -15% in IPA* | 0.07 | 10* | Stable* |
| | 0.05 mL B -15% in IPA | 0.035 | 10 | Stable |
| 40/70 | 0.4 mL B-neat | 0.45 | 100 | Stable |
| | 0.3 mL B-neat | 0.34 | 100 | Stable |
| | 0.53 mL B -15% in IPA | 0.37 | 100 | Stable |
| | 0.4 mL B -15% in IPA | 0.28 | 100 | Stable |
| | 0.3 mL B -15% in IPA | 0.21 | 100 | Stable |
| | 0.3 mL B -15% in IPA* | 0.21* | 100* | Stable* |
| | 0.2 mL B -15% in IPA | 0.14 | 100 | Stable |
| | 0.2 mL B -15% in IPA* | 0.14* | 90* | Stable* |
| | 0.1 mL B -15% in IPA | 0.07 | 90 | Stable |
| | 0.1 mL B -15% in IPA* | 0.07* | 30* | Stable* |
| | 0.05 mL B -15% in IPA | 0.035 | 80 | Not stable |
| | | | | initially |
| | | | | but stable |
| | | | | after 50% |
| | | | | floating |

*slurry prepared in Marcellus water

As can be seen, the consumption of hydrophobicizing agent can be optimized to improve the economics without compromising performance.

### Comparison Between Conventional Proppant Treatment and Spray Proppant Treatment in a Fracturing Operation

Having reference to Table G below, 18 stages in a wellbore were fractured from a bottom or toe of the well, at a total measured depth (TMD) of about 3400 m (TMD), at intervals toward surface, to about 2100 m (TMD).

The first three stages were fractured using a proppant slurry prepared according to the prior art, wherein the hydrophobicizing agent was added to the water used to prepare the slurry, at the suction side of the blender tub or to the slurry at the discharge side of the blender tub.

The remaining 15 stages were fractured using a proppant slurry prepared according to embodiments taught herein. The hydrophobicizing agent was sprayed onto the dry proppant prior to addition of the water, which included at least some other chemical additives conventional for fracturing fluids. In all cases nitrogen, in appropriate amounts, was added to the slurry prior to pumping downhole.

TABLE G

| | Top | Sand 20/40 | Sand 40/70 | Frac Fluid | Hydrophobicizer** | Hydrophobicizer** |
|---|---|---|---|---|---|---|
| | Depth | Tonne per | Tonne per | chemicals* | Conventional | Sprayed |
| Stage | m TMD | stage | stage | L per stage | L per stage | L per stage |
| 1 | 3360 | 20.0 | 1.0 | 586.41 | 166.93 | — |
| 2 | 3300 | 20.0 | 1.0 | 540.69 | 166.93 | — |
| 3 | 3200 | 20.0 | 1.0 | 540.69 | 166.93 | — |
| 4 | 3150 | 20.0 | 1.0 | 540.69 | — | 86.45 |
| 5 | 3100 | 20.0 | 1.0 | 540.69 | — | 86.45 |
| 6 | 3000 | 20.0 | 1.0 | 562.51 | — | 91.86 |
| 7 | 2900 | 20.0 | 1.0 | 562.51 | — | 91.86 |
| 8 | 2800 | 20.0 | 1.0 | 562.51 | — | 91.86 |
| 9 | 2750 | 20.0 | 1.0 | 562.51 | — | 91.86 |
| 10 | 2700 | 20.0 | 1.0 | 562.51 | — | 91.86 |
| 11 | 2600 | 20.0 | 1.0 | 536.39 | — | 97.26 |
| 12 | 2500 | 20.0 | 1.0 | 536.39 | — | 97.26 |
| 13 | 2450 | 20.0 | 1.0 | 536.39 | — | 96.07 |
| 14 | 2350 | 20.0 | 1.0 | 536.39 | — | 96.07 |
| 15 | 2300 | 20.0 | 1.0 | 536.39 | — | 96.07 |
| 16 | 2200 | 20.0 | 1.0 | 536.39 | — | 96.07 |
| 17 | 2100 | 20.0 | 1.0 | 536.39 | — | 96.07 |
| 18 | 2050 | 30.0 | 1.0 | 699.07 | — | 145.13 |

*total volume of biocide, clay control additive, friction reducer, non-emulsifier surfactant and scale inhibitor
**hydrophobicizer = hydrophobicizing additive

As can be seen, there is a significant reduction in the volume of hydrophobicizing additive required per tonne of sand for stages 4-18, using embodiments taught herein, compared to stages 1-3 wherein the slurry was prepared on-the-fly using conventional methods.

### Hydrophobicizing Additive Usage for Spray Proppant Treatment in a Fracturing Operation

Proppant was spray-treated on-the-fly using a hydrophobicizing agent according to embodiments taught herein. The data for preparation of the slurry for each stage of another 18 stage fracturing operation is provided in Table H below. No direct comparisons were made in the wellbore by fracturing stages using conventionally prepared and treated proppant, however Applicant has calculated the amount of hydrophobicizing agent which would have been added to each stage to be about 1500 L, had the slurry been prepared in the conventional manner.

TABLE H

| | | | | | Hydropho- |
|---|---|---|---|---|---|
| | | | | | bicizer |
| | Top | Sand 20/40 | Sand 40/70 | Frac Fluid | Sprayed |
| | Depth | Tonne per | Tonne per | chemicals* | Per stage |
| Stage | m TMD | stage | stage | L per stage | (L) |
| 1 | 4000 | 24 | 36 | 1325.52 | 650.93 |
| 2 | 3925 | 24 | 36 | 1325.52 | 650.93 |
| 3 | 3850 | 24 | 36 | 1325.52 | 650.93 |
| 4 | 3775 | 24 | 36 | 1252.13 | 650.93 |
| 5 | 3700 | 24 | 36 | 1252.13 | 650.93 |
| 6 | 3625 | 24 | 36 | 1252.13 | 650.93 |
| 7 | 3550 | 24 | 36 | 1252.13 | 650.93 |
| 8 | 3475 | 24 | 36 | 1252.13 | 650.93 |
| 9 | 3400 | 24 | 36 | 1252.13 | 650.93 |
| 10 | 3325 | 24 | 36 | 1252.13 | 650.93 |
| 11 | 3250 | 24 | 36 | 1252.13 | 650.93 |
| 12 | 3175 | 24 | 36 | 1252.13 | 650.93 |
| 13 | 3100 | 24 | 36 | 1252.13 | 650.93 |
| 14 | 3025 | 24 | 36 | 1252.13 | 650.93 |
| 15 | 2950 | 24 | 36 | 1252.13 | 650.93 |
| 16 | 2875 | 24 | 36 | 1252.13 | 650.93 |
| 17 | 2800 | 24 | 36 | 1252.13 | 650.93 |
| 18 | 2725 | 24 | 36 | 1270.02 | 650.93 |

When compared to the amount of hydrophobicizing additive which would have been added to the conventionally prepared slurry, embodiments taught herein demonstrate the ability to significantly reduce additive requirements.

### In Use

While embodiments of apparatus and processes taught herein are suitable for on-the-fly spray treatment of proppant P with any additive A which can be sprayed thereon, and which is safe to do so, embodiments are described herein in the context of hydrophobicizing additives A which are used to hydrophobically modify surfaces of proppant P. The hydrophobicization of the proppant P causes the formation of stable sand/bubble aggregations for fracturing operations resulting in desirable proppant packs within fractures produced in the formation.

In embodiments, exemplary hydrophobicizing additives are those marketed by Applicant under SANDSTILL™ and FLOWRIDER® or MVP FRAC™. Embodiments of such exemplary hydrophobicizing additives are taught in Applicant's following US patents and published applications, all of which are incorporated herein by reference in their entirety; U.S. Pat. No. 8,236,738; US Published Application 2014-0243245; U.S. Pat. No. 7,723,274; US Published Application 2010-0197526; U.S. Pat. No. 8,105,986; US Published Application 2012-0071371; US Published Application 2015-0252254 and Published Application US 2015-0307772.

The exemplary hydrophobicizing additives A comprise active hydrophobicizing agents and are typically prepared in a liquid medium, such as alcohol, esters or oil, including but not limited to C5 to C30 straight chain hydrocarbons, for spraying on the proppant. In embodiments, the oil or alcohols may further act to enhance proppant agglomeration and attachment of bubbles to the proppant P.

In embodiments, the liquid hydrocarbon is mineral oil. The mineral oil is added to the hydrophobicizing agent to enhance sand agglomeration, to reduce sand dust and to increase a crush strength of the proppants. In another embodiment, a frother, such as methyl isobutyl carbinol (MIBC), can be used in place of the mineral oil or in combination with mineral oil.

Advantageously, as seen from standard UEL and LEL testing, mineral oil has relatively low flammability and therefore when used in embodiments taught herein, has a reduced risk of igniting at the intake of pumps and the like. Further, mineral oil has low volatility and when sprayed onto proppant presents a low risk for adverse health effects.

Amounts of hydrophobicizing agent required for treatment of proppant is generally dependent upon sand loading and the pumping rate of the slurry.

In use, sand is delivered to the intake end of the one or more augers, such as to the hopper, and is lifted by the one or more augers from the hopper to the discharge end of the auger. Hydrophobicizing additive is metered and delivered to the main spray nozzles 30, and to the auxiliary nozzles 40 and orifices 42, if used. Sufficient hydrophobicizing additive A is supplied for the rate of sand delivery by the one or more augers 12 and the additive A selected for treatment of the sand P surfaces to result in the desired slurry characteristics and the overall rate of slurry delivery required for the fracturing operation. The spray nozzles 30,40 and orifices 42 distribute the hydrophobicizing additive A to the substantially dry sand P as it is discharged from the discharge end 16 of the one or more augers 12 and falls into the blender tub 18. At the same time, the liquid component of the slurry, typically water W, is pumped through the piping 24 on the blender truck 10 into the blender tub 18 for mixing with the sand P. Any additional frac fluid additives, such as polymers, clay control additives, surfactants, scale control additives, corrosion inhibitors, biocides, pH control, breakers and the like, are either added to the water W upstream of the blender tub 18 or are added to the slurry S downstream of the blender tub 18. Thereafter, the slurry S is delivered to surface pumping equipment (not shown) for pumping downhole during the fracturing operation.

By way of example only, exemplary hydrophobizing agents include amine hydrophobizing agents, as well as silicon or fluorinated hydrophobizing agents, described as follows.

The term “amine hydrophobizing agent” is used herein to mean long carbon chain hydrocarbon amines containing no silicon or fluoro-based groups in the molecules. Such compounds contain at least fourteen and preferably at least sixteen carbon atoms, which render the surface of the particulates hydrophobic. The amine hydrophobizing agents, include simple primary, secondary, tertiary amines, primary ether amines, di-amines, polyamines, ether diamines, stearyl amines, tallow amines, condensates of amine or alkanolamine with fatty acid or fatty acid ester, condensates of hydroxyethylendiamines.

Examples include the condensate of diethylenetetraamine and tallow oil fatty acid, tetradecyloxypropyl amine, octadecyloxypropyl amine, hexadecyloxypropyl amine, hexadecyl-1,3-propanediamine, tallow-1,3-propanediamine, hexadecyl amine, tallow amine, soyaalkylamine, erucyl amine, hydrogenated erucyl amine, ethoxylated erucyl amine, rapeseed amine, hydrogenated rapeseed amine, ethoxylated rapeseed amine, ethoxylated oleylamine, hydrogenated oleylamine, ethoxylated hexadecyl amine, octadecylamine, ethoxylated octadecylamine, ditallowamine, hydrogenated soyaalkylamine, amine, hydrogenated tallow amine, di-octadecylamine, ethoxylated (2) tallowalkylamine, for example Ethomeen T/12 or ethoxylated (2) soyaalkylamine, for example, Ethomeen S/12, or oleyl amine, for example Armenn OL, or di-cocoalkalamine, for example Armeen 2C from Akzo Nobel Inc., and the condensate of an excess of fatty acids with diethanolamine.

The term “silicon or fluorinated hydrophobizing agents” is used herein to mean the hydrophobizing agents disclosed, for example, in U.S. Pat. No. 7,723,274, which include different organosilanes, organosiloxanes, polysiloxanes modified with different functional groups, including cationic, amphoteric as well as anionic groups, fluorinated silanes, fluorinated siloxanes and fluorinated hydrocarbon compounds. In general, organosilanes are compounds containing silicon to carbon bonds. Organosiloxanes are compounds containing Si—O—Si bonds. Polysiloxanes are compounds in which the elements silicon and oxygen alternate in the molecular skeleton, i.e., Si—O—Si bonds are repeated. The simplest polysiloxanes are polydimethylsiloxanes. Polysiloxane compounds can be modified by various organic substitutes having different numbers of carbons, which may contain N, S, or P moieties that impart desired characteristics. For example, cationic polysiloxanes are compounds in which one or more organic cationic groups are attached to the polysiloxane chain, either at the middle or the end or both at the same time. The most common organic cationic groups are organic amine derivatives including primary, secondary, tertiary and quaternary amines (for example, quaternary polysiloxanes including, quaternary polysiloxanes including mono- as well as di-quaternary polysiloxanes, amido quaternary polysiloxanes, imidazoline quaternary polysiloxanes and carboxy quaternary polysiloxanes). Similarly, the polysiloxane can be modified by organic amphoteric groups, where one or more organic amphoteric groups are attached to the polysiloxane chain, either at the middle or the end or both, and include betaine polysiloxanes and phosphobetaine polysiloxanes. Among different organosiloxane compounds which are useful for the present invention, polysiloxanes modified with organic amphoteric or cationic groups including organic betaine polysiloxanes and organic quaternary polysiloxanes are examples. One type of betaine polysiloxane or quaternary polysiloxane is represented by the formula

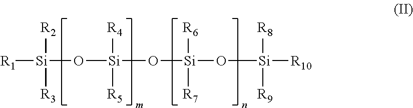

wherein each of the groups R₁ to R₆, and R₈ to R₁₀ represents an alkyl containing 1-6 carbon atoms, typically a methyl group, R₇ represents an organic betaine group for betaine polysiloxane, or an organic quaternary group for quaternary polysiloxane, and have different numbers of carbon atoms, and may contain a hydroxyl group or other functional groups containing N, P or S, and m and n are from 1 to 200. For example, one type of quaternary polysiloxanes is when R⁷ is represented by the group

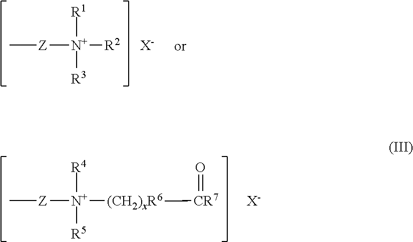

wherein R¹, R², R³ are alkyl groups with 1 to 22 carbon atoms or alkenyl groups with 2 to 22 carbon atoms. R⁴, R⁵, R⁷ are alkyl groups with 1 to 22 carbon atoms or alkenyl groups with 2 to 22 carbon atoms; R⁶ is —O— or the NR⁸ group, R⁸ being an alkyl or hydroxyalkyl group with 1 to 4 carbon atoms or a hydrogen group; Z is a bivalent hydrocarbon group, which may have a hydroxyl group and may be interrupted by an oxygen atom, an amino group or an amide group; x is 2 to 4; The R¹, R², R³, R⁴, R⁵, R⁷ may be the same or different, and X⁻ is an inorganic or organic anion including Cl⁻ and CH₃COO⁻.

Examples of organic quaternary groups include [R—N+(CH₃)₂—CH₂CH(OH)CH₂—O—(CH₂)₃—](CH₃COO⁻), wherein R is an alkyl group containing from 1-22 carbons or an benzyl radical and CH₃COO⁻ an anion. Examples of organic betaine include —(CH₂)₃—O—CH₂CH(OH)(CH₂)—N+(CH₃)₂CH₂COO⁻. Such compounds are commercial available. It should be understood that cationic polysiloxanes include compounds represented by formula (II), wherein R₇ represents other organic amine derivatives including organic primary, secondary and tertiary amines. Other example of organo-modified polysiloxanes include di-betaine polysiloxanes and di-quaternary polysiloxanes, which can be represented by the formula

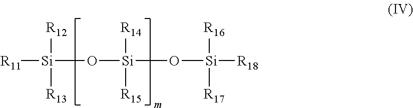

wherein the groups R₁₂ to R₁₇ each represents an alkyl containing 1-6 carbon atoms, typically a methyl group, both R₁₁ and R₁₈ group represent an organic betaine group for di-betaine polysiloxanes or an organic quaternary group for di-quaternary, and have different numbers of carbon atoms and may contain a hydroxyl group or other functional groups containing N, P or S, and m is from 1 to 200. For example, one type of di-quaternary polysiloxanes is when R₁₁ and R₁₈ are represented by the group

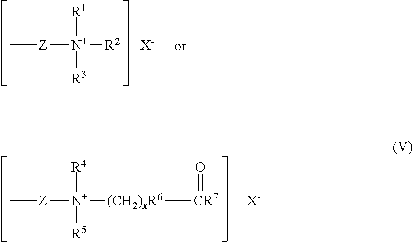

wherein R¹, R², R³, R⁴, R⁵, R⁶, R⁷, Z, X⁻ and x are the same as defined above. Such compounds are commercially available. Quaternium 80 (INCI) is one of the commercial examples.

Similarly, the polysiloxane can be modified by organic anionic groups, where one or more organic anionic groups are attached to the polysiloxane chain, either at the middle or the end or both, including sulfate polysiloxanes, phosphate polysiloxanes, carboxylate polysiloxanes, sulfonate polysiloxanes, thiosulfate polysiloxanes.

The organosiloxane compounds also include alkylsiloxanes including hexamethylcyclotrisiloxane, octamethylcyclotetrasiloxane, decamethylcyclopentasiloxane, hexamethyldisiloxane, hexaethyldisiloxane, 1,3-divinyl-1,1,3,3-tetramethyldisiloxane, octamethyltrisiloxane, decamethyltetrasiloxane. The organosilane compounds include alkylchlorosilane, for example methyltrichlorosilane, dimethyldichlorosilane, trimethylchlorosilane, octadecyltrichlorosilane; alkyl-alkoxysilane compounds, for example methyl-, propyl-, isobutyl- and octyltrialkoxysilanes, and fluoro-organosilane compounds, for example, 2-(n-perfluoro-octyl)-ethyltriethoxysilane, and perfluoro-octyldimethyl chlorosilane. Other types of chemical compounds, which are not organosilicone compounds and which can be used to render proppant surfaces hydrophobic are certain fluoro-substituted compounds, for example certain fluoro-organic compounds including cationic fluoro-organic compounds.

Further information regarding organosilicon compounds can be found in U.S. Pat. No. 7,723,274, in Silicone Surfactants (Randal M. Hill, 1999) and the references therein, and in U.S. Pat. Nos. 4,046,795; 4,537,595; 4,564,456; 4,689,085; 4,960,845; 5,098,979; 5,149,765; 5,209,775; 5,240,760; 5,256,805; 5,359,104; 6,132,638 and 6,830,811 and Canadian Patent No. 2,213,168. Organosilanes can be represented by the formula

RₙSiX₍₄₋ₙ₎ (I)

wherein R is an organic radical having 1-50 carbon atoms that may possess functionality containing N, S, or P moieties that imparts desired characteristics, X is a halogen, alkoxy, acyloxy or amine and n has a value of 1-3. Examples of suitable organosilanes include:

Si(OCH₃)₄, CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHCH₂Si(OCH₃)₃, (CH₃)₂Si(OCH₃)₂, (CH₂═CH)Si(CH₃)₂Cl, (CH₃)₂Si(OCH₂CH₃)₂, (CH₃)₂Si(OCH₂CH₂CH₃)₂, (CH₃)₂Si[O(CH₂)₃CH₃]₂, (CH₃CH₂)₂Si(OCH₂CH₃)₂, (C₆H₅)₂Si(OCH₃)₂, (C₆H₅CH₂)₂Si(OCH₃)₂, (C₆H₅)₂Si(OCH₂CH₃)₂, (CH₂═CH)Si(OCH₃)₂, (CH₂═CHCH₂)₂Si(OCH₃)₂, (CH₃)₃SiOCH₃, CH₃HSi(OCH₃)₂, (CH₃)₂HSi(OCH₃), CH₃Si(OCH₂CH₂CH₃)₃, CH₂═CHCH₂Si(OCH₂CH₂OCH₃)₃, (C₆H₅)₂Si(OCH₂CH₂OCH₃)₂, (CH₃)₂Si(OCH₂CH₂OCH₃)₂, (CH₂═CH₂)₂Si(OCH₂CH₂OCH₃)₂, (CH₂═CHCH₂)₂Si(OCH₂CH₂OCH₃)₂, (C₆H₅)₂Si(OCH₂CH₂OCH₃)₂, CH₃Si(CH₃COO)₃, 3-aminotriethoxysilane, methyldiethylchlorosilane, butyltrichlorosilane, diphenyldichlorosilane, vinyltrichlorosilane, methyltrimethoxysilane, vinyltriethoxysilane, vinyltris(methoxyethoxy)silane, methacryloxypropyltrimethoxysilane, glycidoxypropyltrimethoxysilane, aminopropyltriethoxysilane, divinyldi-2-methoxysilane, ethyltributoxysilane, isobutyltrimethoxysilane, hexyltrimethoxysilane, n-octyltriethoxysilane, dihexyldimethoxysilane, octadecyltrichlorosilane, octadecyltrimethoxysilane, octadecyldimethylchlorosilane, octadecyldimethylmethoxysilane and quaternary ammonium silanes including 3-(trimethoxysilyl)propyldimethyloctadecyl ammonium chloride, 3-(trimethoxysilyl)propyldimethyloctadecyl ammonium bromide, 3-(trimethylethoxysilylpropyl)didecylmethyl ammonium chloride, triethoxysilyl soyapropyl dimonium chloride, 3-(trimethylethoxysilylpropyl)didecylmethyl ammonium bromide, 3-(trimethylethoxysilylpropyl)didecylmethyl ammonium bromide, triethoxysilyl soyapropyl dimonium bromide, (CH₃O)₃Si(CH₂)₃P⁺(C₆H₅)₃Cl, (CH₃O)₃Si(CH₂)₃P⁺(C₆H₅)₃Br⁻, (CH₃O)₃Si(CH₂)₃P⁺(CH₃)₃Cl⁻, (CH₃O)₃Si(CH₂)₃P⁺(C₆H₁₃)₃Cl⁻, (CH₃O)₃Si(CH₂)₃N⁺(CH₃)₂C₄H₉Cl, (CH₃O)₃Si(CH₂)₃N⁺(CH₃)₂CH₂C₆H₅Cl⁻, (CH₃O)₃Si(CH₂)₃N+(CH₃)₂CH₂CH₂OHCl⁻, (CH₃O)₃Si(CH₂)₃N⁺(C₂H₅)₃Cl⁻, (C₂H₅O)₃Si(CH₂)₃N⁺(CH₃)₂C₁₈H₃₇Cl⁻.

The embodiments in which an exclusive property or privilege are claimed are defined as follows:

1. Apparatus, adapted for use with one or more inclined augers supplying proppant to a blender tub for mixing the proppant with a liquid for preparing a proppant slurry, comprises:
one or more main spray nozzles mounted above a discharge end of each of the one or more inclined augers so as to distribute an additive to substantially dry proppant discharging to fall from the discharge end of the auger into the blender tub;
wherein the one or more main spray nozzles distribute the additive generally in a direction of fall of the discharging proppant.

2. The apparatus of claim 1 further comprising:
one or more auxiliary spray nozzles mounted adjacent the discharge end of the auger and protruding into the discharging proppant,
wherein the one or more auxiliary spray nozzles distribute the additive within and beneath the proppant.

3. The apparatus of claim 1 further comprising one or more spray orifices mounted adjacent the discharge end of the auger,
wherein the one or more spray orifices distribute the additive substantially perpendicular to the direction of fall of the proppant.

4. The apparatus of claim 3 wherein the one or more spray orifices are formed in a spray bar mounted to the auger downstream of the discharge end thereof.

5. The apparatus of claim 4 further comprising one or more auxiliary spray nozzles mounted to the spray bar,
wherein the one or more auxiliary spray nozzles distribute the additive within and beneath the proppant.

6. The apparatus of claim 1 wherein the proppant slurry is for a fracturing operation and the additive hydrophobically modifies surfaces of the proppant.

7. The apparatus of claim 1 further comprising:
manifolding for delivering the additive to the one or more main nozzles.

8. The apparatus of claim 5 further comprising:
manifolding for delivering the additive to the one or more main nozzles, the one or more auxiliary nozzles and the one or more spray orifices.

9. The apparatus of claim 1 wherein each of the one or more main nozzles form a spray pattern and wherein the one or more main nozzles are two or more main nozzles, the two or more main nozzles are spaced to overlap the spray pattern from adjacent main nozzles of the two or more main nozzles.

10. The apparatus of claim 2 wherein each of the one or more auxiliary nozzles form a spray pattern and wherein the one or more auxiliary nozzles are two or more auxiliary nozzles, the two or more auxiliary nozzles are spaced to overlap the spray pattern from adjacent auxiliary nozzles of the two or more auxiliary nozzles.

11. A method for forming a proppant slurry on-the-fly comprising:
lifting a substantially dry proppant above a blender tub for falling therefrom into the blender tub;
distributing an additive onto the falling proppant, generally in a direction of fall of the proppant for distributing the additive onto the proppant surfaces forming a modified proppant; and thereafter
introducing liquid into the modified proppant for mixing therewith for forming the slurry.

12. The method of claim 11 wherein the slurry is for use in a fracturing operation and the additive is distributed to the proppant in an amount relative to proppant loading and a pumping rate of the slurry into a wellbore.

13. The method of claim 11 wherein distributing the additive comprises:
spraying the additive from above onto the falling proppant and in the direction of fall of the proppant.

14. The method of claim 11 wherein distributing the additive further comprises:
spraying the additive within the falling proppant.

15. The method of claim 14 further comprising:
spraying the additive within the falling proppant substantially perpendicular to the fall of the proppant.

16. The method of claim 12 wherein the additive hydrophobically modifies the surfaces of the proppant further comprising:
introducing additional additives in the liquid.

17. The method of claim 12 wherein the additive hydrophobically modifies the surfaces of the proppant further comprising:
introducing additional additives to the slurry downstream of forming the slurry.

18. The method of claim 12 wherein the additive hydrophobically modifies the surfaces of the proppant further comprising:
selecting the additive to be compatible with additional additives to be added to the proppant slurry.

19. The method of claim 12 wherein the additive hydrophobically modifies the surfaces of the proppant further comprising:
selecting the additive to be compatible with liquid to be added to the proppant slurry.

20. The method of claim 12 wherein the additive is a hydrophobicizing agent further comprising:
distributing from about 0.1 L to about 40 L of the hydrophobicizing agent per metric tonne of proppant.

21. The method of claim 20 further comprising:
distributing from about 2 L to about 20 L of the hydrophobicizing agent per metric tonne of proppant.

22. The method of claim 12 wherein the additive is a hydrophobicizing agent and the proppant loading is from about 0.01 kg/m³ to about 2200 kg/m³ of the proppant slurry further comprising:
distributing the hydrophobicizing agent to the proppant at about 0.1 L/min to about 300 L/min.
